(19) United States
(12) Patent Application Publication
(10) Pub. No.: US 2009/0031104 A1
(43) Pub. Date: Jan. 29, 2009

(54) Low Latency Massive Parallel Data Processing Device

(76) Inventors: Martin Vorbach, Lingenfeld (DE); Frank May, Munchen (DE)

Correspondence Address: KENYON & KENYON LLP, ONE BROADWAY, NEW YORK, NY, 10004, US

(21) Appl. No.: 11/883,670

(22) PCT Filed: Feb. 6, 2006
(86) PCT No.: PCT/EP2006/001014

§ 371 Date: Feb. 11, 2008

(30) Foreign Application Priority Data
Feb. 7, 2005 (DE) 10 2005 005 766.7
Feb. 15, 2005 (EP) 05003174.9
Mar. 7, 2005 (DE) 10 2005 010 846.6
Mar. 17, 2005 (EP) 05005832.0
Mar. 30, 2005 (DE) 10 2005 014 860.3
May 19, 2005 (DE) 10 2005 023 785.1
Sep. 6, 2005 (EP) 05019296.2

(51) Int. Cl. G06F 15/80; G06F 9/06

(52) U.S. Cl. 712/18; 712/E09.003

(57) ABSTRACT

Data processing device comprising a multidimensional array of ALUs, having at least two dimensions where the number of ALUs in the dimension is greater or equal to 2, adapted to process data without register caused latency between at least some of the ALUs in the corresponding array.

The present invention relates to a method of data processing and in particular to an optimized architecture for a processor having an execution pipeline allowing on each stage of the pipeline the conditional execution and in particular conditional jumps without reducing the overall performance due to stalls of the pipeline. The architecture according to the present invention is particularly adapted to process any sequential algorithm, in particular Huffman-like algorithms, e.g. CAVLC and arithmetic codecs like CABAC having a large number of conditions and jumps. Furthermore, the present invention is particularly suited for intra-frame coding, e.g. as suggested by the video codecs H.264.

Data processing requires the optimization of the available resources, as well as the power consumption of the circuits involved in data processing. This is the case in particular when reconfigurable processors are used.

Reconfigurable architecture includes modules (VPU) having a configurable function and/or interconnection, in particular integrated modules having a plurality of unidimensionally or multidimensionally positioned arithmetic and/or logic and/or analog and/or storage and/or internally/externally interconnecting modules, which are connected to one another either directly or via a bus system.

These generic modules include in particular systolic arrays, neural networks, multiprocessor systems, processors having a plurality of arithmetic units and/or logic cells and/or communication/peripheral cells (IO), interconnecting and networking modules such as crossbar switches, as well as known modules of the type FPGA, DPGA, Chameleon, XPUTER, etc. Reference is also made in particular in this context to the following patents and patent applications of the same applicant:

P 44 16 881.0-53, DE 197 81 412.3, DE 197 81 483.2, DE 196 54 846.2-53, DE 196 54 593.5-53, DE 197 04 044.6-53, DE 198 80 129.7, DE 198 61 088.2-53, DE 199 80 312.9, PCT/DE 00/01869, DE 100 36 627.9-33, DE 100 28 397.7, DE 101 10 530.4, DE 101 11 014.6, PCT/EP 00/10516, EP 01 102 674.7, DE 102 06 856.9, 60/317,876, DE 102 02 044.2, DE 101 29 237.6-53, DE 101 39 170.6, PCT/EP 03/09957, PCT/EP 2004/006547, EP 03 015 015.5, PCT/EP 2004/009640, PCT/EP 2004/003603, EP 04 013 557.6.

It is to be noted that the cited documents are enclosed for purpose of the enclosure in particular with respect to the details of configuration, routing, placing, design of architecture elements, trigger methods and so forth. It should be noted that whereas the cited documents refer in certain embodiments to configuration using dedicated configuration lines, this is not absolutely necessary. It will be understood from the present invention that it might be possible to transfer instructions intermeshed with data using the same input lines to the processing architecture without deviating from the scope of invention. Furthermore, it is to be noted that the present invention does disclose a core which can be used in an environment using any protocols for communication and that it can, in particular, be enclosed with protocol registers at the in- and output side thereof. Furthermore, it is obvious, in particular, though not only in hyper-thread applications, that the invention disclosed herein may be used as part of any other processor, in particular multi-core processors and the like.

The object of the present invention is to provide novelties for the industrial application.

This object is achieved by the subject matter of the independent claims. Preferred embodiments can be found in the dependent claims.

Most processors according to the state of the art use pipe-lining or vector arithmetic logics to increase the performance. In case of conditions, in particular conditional jumps, the execution within the pipeline and/or the vector arithmetic logics has to be stopped. In the worst case scenario even calculations carried out already have to be discarded. These so-called pipeline-stalls waste from ten to thirty clock-cycles depending on the particular processor architecture. Should they occur frequently, the overall performance of the processor is significantly affected. Thus, frequent pipeline-stalls may reduce the processing power of a two GHz-processor to a processing power actually used of that of a 100 MHz-processor. Thus, in order to reduce pipeline-stalls, complicated methods such as branch-prediction and -predication are used which however are very inefficient with respect to energy consumption and silicon area.

In contrast, VLIW-processors are more flexible at first sight than deeply pipelined architectures; however, in cases of jumps the entire instruction word is discarded as well; furthermore pipeline and/or a vector arithmetic logic should be integrated.

The processor architecture according to the present invention can effect arbitrary jumps within the pipeline and does not need complex additional hardware such as those used for branch-prediction. Since no pipeline-stalls occur, the architecture achieves a significant higher average performance close to the theoretical maximum compared to conventional processors, in particular for algorithms comprising a large number of jumps and/or conditions.

The invention is suited not only for use as e.g. a conventional microprocessor but also as a coprocessor and/or for coupling with a reconfigurable architecture. Different methods of coupling may be used, for example a “loose” coupling using a common bus and/or memory, the coupling to a (reconfigurable) processor using a so-called coprocessor-interface, the integration of reconfigurable units in the data path of the reconfigurable processor and/or the coupling of both architectures as thread resources in a hyper-thread architecture. Reference is made to PCT/EP 2004/003603 (PACT50/PCTE) regarding couplings, in particular in view of hyper-thread architectures. The disclosure of the cited document is enclosed for reference in its entirety.

The architecture of the present invention has significant advantages over known processor architectures as long as data processing is effected in a way comprising significant amounts of sequential operations, in particular compared to VLIW architectures. The present architecture maintains a high-level performance compared to other processor-, coprocessor and generally speaking data processing units such as VLIWs, if the algorithm to be executed comprises a significant amount of instructions to be executed in parallel thus comprising implicit vector transformability or an instruction-level-parallelity ILP, as then advantages of meshing and connectivity of the given processor architecture particularities can be realized fully.

This is particularly the case where data processing steps have to be executed that can commonly best be mapped onto sequencer structures.

### Architecture According to the Invention

Be it noted that in the following part, reference is made to the architecture according to the invention as a processor. However, it is to be understood that whereas the present invention can be considered to be a fully working processor and/or can be used to build such a fully working processor, it is also possible to derive only a processor core or, more generally speaking, a data processing core for use in a more complex environment such as multi-core processors where the core of the present invention can form one of many cores, in particular cores that may be different from each other. Furthermore, it will become obvious that the core of the present invention might be used to form a processing array element or circuitry included in a (coarse- and/or medium-grained) “sea of logic”. However, despite these remarks, the following description will refer in most parts to a processor according to the invention yet without limitation and only to enable easier understanding of the invention to those skilled in the art. More generally speaking, not citing, relating to or repeating in every paragraph, sentence and/or for every verb and/or object and/or subject or other given grammatical construction any and all or at least some of possible, feasible, helpful or even less valued alternatives and/or options, often despite the fact that said referral might be deemed a necessary or helpful part of a more complete disclosure though deemed so not by a skilled person but a patent examiner, patent employee, attorney or judge construing such linguistic ramifications instead of focussing on the technical issues to be really addressed by a description disclosing technical ideas, is in no way understood to reduce the scope of disclosure.

This being stated, the processor according to the present invention (XMP) comprises several ALU-stages connected in a row, each ALU-stage executing instructions in response to the status of previous ALU-stages in a conditional manner. In order to be capable of executing any given program structure, complete program flow-trees can be executed by storing on each ALU-stage plane the maximum number of instructions possibly executable on the respective plane. Using the status of the previous stages and/or the processor status register respectively, the instruction for a stage to be actually executed respectively is determined from clock-cycle to clock-cycle. In order to implement a complete program flow-tree, the execution of one instruction in the first ALU-stage is necessary, in the second ALU-stage, the conditional execution of one instruction out of (at least) two, on the third ALU-stage the conditional execution of one instruction out of (at least) four and on the n.th stage the conditional execution of an OpCode out of (at least) 2ⁿ is required. All ALUs may have and will have in the preferred embodiment reading and writing access to the common register set. Preferably, the result of one ALU-stage is sent to the subsequent ALU-stage as operand. It should be noted that here “result” might refer to result-related data such as carry; overflow; sign flags and the like as well. Pipeline register stages may be used between different ALU-stages. In particular, it can be implemented to provide a pipeline-like register stage not down-stream of every ALU-stage but only downstream of a given group of ALUs. In particular, the group-wise relation between ALUs and pipeline stages is preferred in a manner such that within an ALU group only exactly one conditional execution can occur.

### A PREFERRED EMBODIMENT OF THE ALU-STAGES

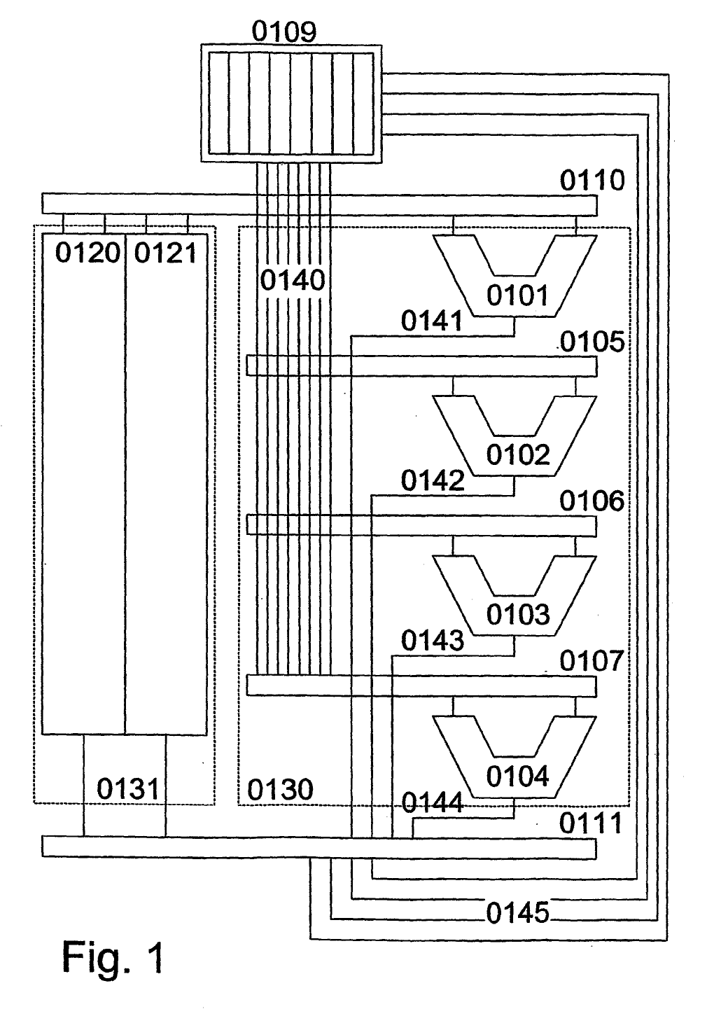

FIG. 1 shows the basic design of the data path of the present processor (XMP). Data and/or address registers of the processor are designated by 0109. Four ALU-stages are designated as 0101, 0102, 0103, 0104. The stages are connected to each other in a pipeline-like manner, a multiplexer-/register stage 0105, 0106, 0107 following each ALU. The multiplexer in each stage selects the source for the operand of the following ALU, the source being in this embodiment either the processor register or the results of respective previous ALUs. In this embodiment, the preferred implementation is used where a multiplexer can select as operand the result of any upstream ALU independent on how far upstream the ALU is positioned relative to the respective multiplexer and/or independent on what column the ALU is placed in. As the ALU-results can be taken over directly from the previous ALU, they do not have to be written back into the processor register. Therefore, the ALU-/register-data transfer is particularly simple and energy efficient in the machine suggested and disclosed. At the same time, there is no problem of data dependencies that are difficult to resolve (in particular difficult to resolve by compilers). Thus data dependencies between ALUs as well-known from VLIW-processors do not pose a problem here.

A register stage optionally following the multiplexer is decoupling the data transfer between ALU-stages in a pipelined manner. It is to be noted that in a preferred embodiment there is no such register stage implemented. Directly following the output of the processor register 0109, a multiplexer stage 0110 is provided selecting the operands for the first ALU-stage. A further multiplexer stage 0111 is selecting the results of the ALU-stages for the target registers in 0109.

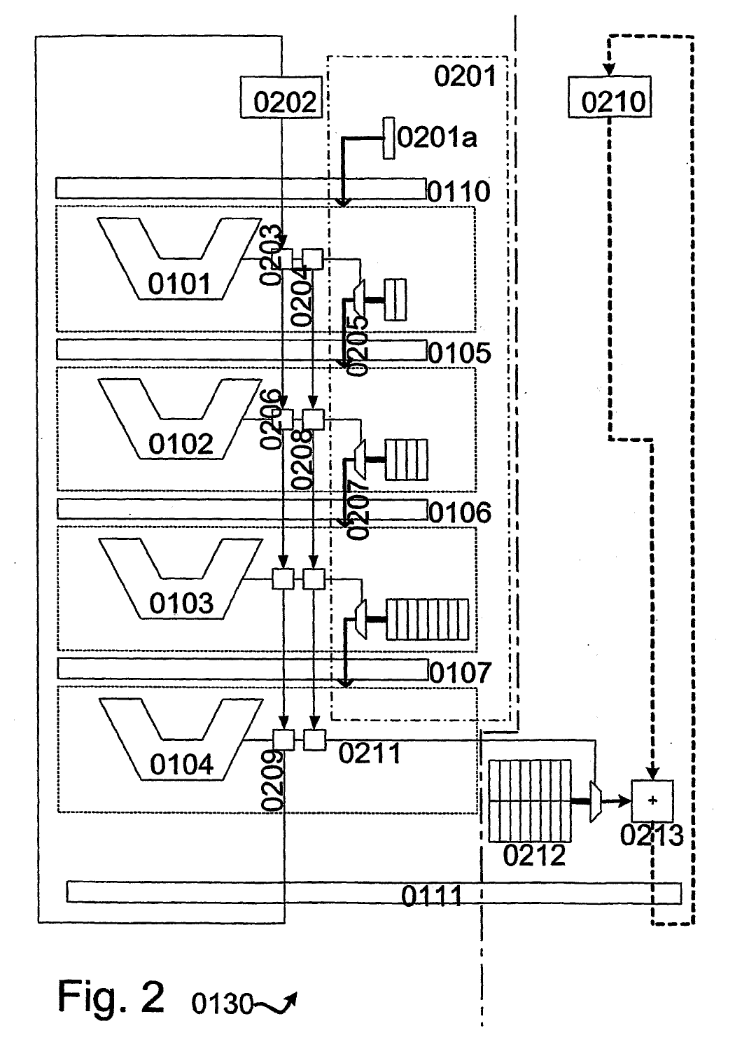

FIG. 2 shows the program flow control for the ALU-stage arrangement 0130 of FIG. 1. The instruction register 0201 holds the instruction to be executed at a given time within 0130. As is known from processors of the prior art, instructions are fetched by an instruction fetcher in the usual manner, the instruction fetcher fetching the instruction to be executed from the address in the program memory defined by the program pointer PP (0210).

The first ALU stage 0101 is executing an instruction 0201a defined in a fixed manner by the instruction register 0201 determining the operands for the ALU using the multiplexer stage 0110; furthermore, the function of the ALU is set in a similar manner. The ALU-flag generated by 0101 may be combined (0203) with the processor flag register 0202 and is sent to the subsequent ALU 0102 as the flag input data thereof.

Each ALU-stage within 0103 can generate a status in response to which subsequent stages execute the corresponding jump without delay and continue with a corresponding instruction.

In dependence of the status obtained in 0203 one instruction 0205 of two possible instructions from 0201 is selected for ALU-stage 0102 by a multiplexer. The selection of the jump target is transferred by a jump vector 0204 to the subsequent ALU-stage. Depending on the instruction selected 0205, the multiplexer stage 0105 selects the operands for the subsequent ALU-stage 0102. Furthermore, the function of the ALU-stage 0102 is determined by the selected instruction 0205.

The ALU-flag generated by 0102 is combined with the flag 0204 received from 0101 (compare 0206) and is transmitted to the subsequent ALU 0103 as the flag input data thereof. Depending on the status obtained in 0206 and depending on the jump vector 0204 received from the previous ALU 0102, the multiplexer selects one instruction 0207 out of four possible instructions from 0201 for ALU-stage 0103.

ALU-stage 0101 has two possible jump targets, resulting in two possible instructions for ALU 0102. ALU 0102 in turn has two jump targets, this however being the case for each of the two jump targets of 0101. In other words, a binary tree of possible jump targets is created, each node of said tree having two branches here. In this way, ALU 0102 has 2ⁿ=4 possible jump targets that are stored in 0201.

The jump target selected is transmitted via signals 0208 to the subsequent ALU-stage 0103. Depending on the instruction 0207 selected, the multiplexer stage 0106 selects the operands for the subsequent ALU-stage 0103. Also, the function of the ALU-stage 0103 is determined by the selected instruction 0207.

The processing in the ALU-stages 0103, 0104 corresponds to the description of the other stages 0101 and 0102 respectively; however, the instruction set from which is to be selected according to the predefined condition is 8 (for 0103) or 16 (for 0104) respectively. In the same way as in the preceeding stages a jump vector 0211 with 2ⁿ=16 (n=number_of_stages=4) jump targets is generated at the output of ALU-stage 0104. This output is sent to a multiplexer selecting one out of sixteen possible addresses 0212 as address for the next OpCode to be executed. The jump address memory is preferably implemented as part of the instruction word 0201. Preferably, addresses are stored in the jump address memory 0212 in a relative manner (e.g. +/−127), adding the selected jump address using 0213 to the current program pointer 0210 and sending the program pointer to the next instruction to be loaded and executed. Note: In one embodiment of the present invention only one valid instruction is selectable for each ALU-stage while all other selections just issue NOP (no operation) or “invalid” instructions; reference is made to the attachment, forming part of the disclosure.

Flags of ALU-stage 0104 are combined with the flags obtained from the previous stages in the same manner as in the previous ALU-stage (compare 0209) and are written back into the flag register. This flag is the result flag of all ALU-operations within the ALU-stage arrangement 0130 and will be used as flag input to the ALU-path 0130 in the next cycle.

The preferred embodiment having four ALU-stages and having subsequent pipeline registers is an example only. It will be obvious to the average skilled person that an implementation can deviate from the shown arrangement such as for example with regard to the number of ALU-stages, the number and placement of pipeline stages, the number of columns, their connection to neighboring and/or non-neighboring columns and/or the arrangement and design of the register set.

The basic method of data processing allows for each ALU-stage of the multi-ALU-stage arrangement to execute and/or generate conditions and/or jumps. The result of the condition or the jump target respectively is transferred via flag vectors, e.g. 0206, or jump vectors, e.g. 0208, to the respective subsequent ALU-stage, executing its operation depending on the incoming vectors, e.g. 0206 and 0208 by using flags and/or flag vectors for data processing, e.g. as operands and/or by selecting instructions to be executed by the jump vectors. This may include selecting the no-operation instruction, effectively disabling the ALU. Within the ALU-stage arrangement 0130 each ALU can execute arbitrary jumps which are implicitly coded within the instruction word 0201 without requiring and/or executing an explicit jump command. The program pointer is after the execution of the operations in the ALU-stage arrangement via 0213, leading to the execution of a jump to the next instruction to be loaded.

The processor flag 0202 is consumed from the ALU-stages one after the other and combined and/or replaced with the result flag of the respective ALU. At the output of the ALU-stage arrangement (ALU-path) the result flag of the final result of all ALUs is returned to the processor flag register 0202 and defines the new processor status.

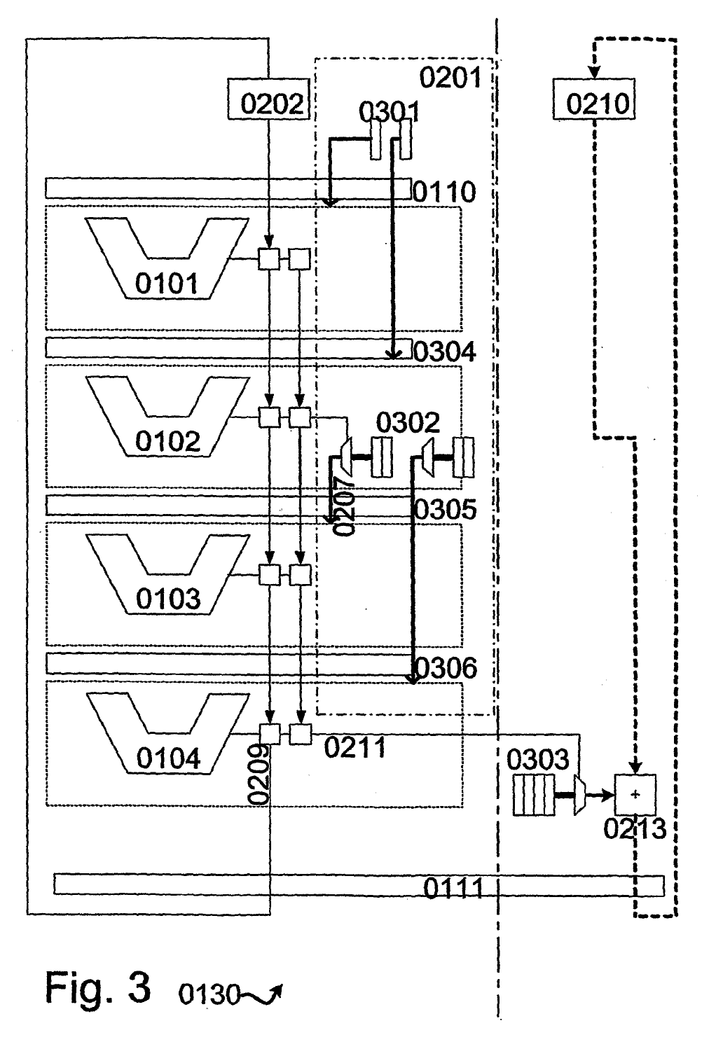

The design or construction of the ALU-stage according to FIG. 2 can be become very complex and consumptious, given the fact that a large plurality of jumps can be executed, increasing on the one hand the area needed while on the other hand increasing the complexity of the design and simulation. In view of the fact that most algorithms do not require plural branching directly one after the other, the ALU-path may be simplified. As an exemplary suggestion an embodiment thereof is shown in FIG. 3. According to FIG. 3, the general design closely corresponds to that of FIG. 2 restricting however the set of possible jumps to two. The instructions for the first two ALUs 0101 and 0102 are coded in the instruction registers 0301 in a fixed manner (fixed manner does not imply that the instruction is fixed during the hardware design process, but that it need not be altered during the execution of one program part loaded at one time into the device of FIG. 3). ALU-stage 0102 can execute a jump, so that for ALU-stages 0103 and 0104 two instructions each are stored in 0302, one of each pair of instructions being selected at runtime depending on the jump target in response to the status of the ALU-stage 0102 using a multiplexer. ALU-stage 0104 can execute a jump having four possible targets stored in 0303. A target is selected by a multiplexer at runtime depending on the status of ALU-stage 0104 and is combined with a program pointer 0210 using an adder 0213. A multiplexer stage 0304, 0305, 0306 is provided between each ALU-stages that may comprise a register stage each. Preferably, no register stage is implemented so as to reduce latency.

### Instructions Connected in Parallel

Preferably, in the other stage arrangement 0101, 0102, 0103, 0104=0130 only instructions simple and executable fast with respect to time are implemented in the ALU. This is preferred and does not result in significant restrictions. Due to the fact that the most frequent instructions within a program do correspond to this restriction (compare for example instructions ADD, SUB, SHL, SHR, CMP, . . . ), more complex instructions having a longer processing time and thus limiting ALU-stage arrangements with respect to their clock frequencies may be connected as side ALUs 0131, preferably in parallel to the previously described ALU-stage arrangement. Two “side-ALUs” are shown to be implemented as 0120 and 0121. More complex instructions as referred to can be multipliers, complex shifters and dividers.

It should be explicitly mentioned that in a preferred embodiment in particular any instructions that require a large area on the processor chip for their implementation can and will be implemented in the side-ALU arrangement instead of being implemented within each ALU. It is an alternative possibility to not allow for the execution of such instructions requiring larger areas for their hardware implementation not in every ALU of the ALU-stages but only in a subset thereof, for example in every second ALU.

Side-ALUs 0131, although drawn in the figure at the side of the pipeline, need not be physically placed at the side of the ALU-stage/pipeline-arrangement. Instead, they might be implemented on top thereof and/or beneath thereof, depending on the possibilities of the actual process used for building the processor in hardware. Side-ALUs 0131 receive their operands as necessary via a multiplexer 0110 from processor register 0109 and write back results to the processor register using multiplexer 0111. Thus, the way side-ALUs receive the necessary operands corresponds to the way the ALU-stage arrangement receives operands. It should be noted that instead of only receiving operands from the processor register 0109, the side-ALUs might be connected to the outputs of one ALU, ALU-stage or a plurality of ALU-stages as well. While in some machine models an instruction group is executed in the ALU-stage arrangement 0130 or the side-ALU 0131, a hyper-scalar execution model processing data simultaneously in both ALU-units 0130 and 0131 is implementable as well.

By way of integration of reconfigurable processors, e.g. a VPU in a side-ALU a close connection and coupling to the sequential architecture is provided. It should be noted that the processor in a processor core of the present invention might be coupled itself to a reconfigurable processor, that is an array of reconfigurable elements. Then, in turn, side-ALUs may comprise reconfigurable processors. These processors may have reduced complexity, compared to the processing array that the ALU-arrangement 0130 is coupled to, e.g. by providing less processing elements and/or only next-neighbor-connections and/or different protocols. It should be noted that it is easily possible to obtain a Babushka- (or chain-)like coupling if preferred. It is also to be noted that the side-ALU might transfer data to a larger array if needed. Furthermore, it is to be noted that where side-ALU comprise reconfigurable processors, the architecture and/or protocol thereof need not necessarily be the same as that the ALU-arrangement of the present invention is coupled to on a larger scale; that means that when considered as Babushkas, the outer Babushka reconfigurable processor array might have a different protocol compared to that of an inner Babushka reconfigurable processor array. The reason for this results in the fact that for smaller arrays, different protocols and/or connectivities might be useful. For example, when the ALU-arrangement of the present invention is coupled to a 20×20 processing array and comprises a smaller reconfigurable processing array in its ALU, e.g. a 3×3 array, there might not be the need to provide non next-neighbour connectivities in the 3×3 array, particularly in case where multidimensional toroidal connectivity is given. Also, there will not necessarily be the necessity to partially reconfigure the inner Babushka processor arrays. In a smaller array of a side-ALU, it might be sufficient to provide for reconfiguration of the entire (smaller) array only.

It should be noted that although the side-units 0131 are referred to above and in the following to be side-“ALUs”, in the same way that an XPP-like array can be coupled to the architecture of the invention as a side-ALU, other units may be used as “ALUs”, for example and without limitation lookup-tables, RAMs, ROMs, FIFOs or other kinds of memories, in particular memories that can be written in and/or read out from each and/or a plurality of the ALU-stages or ALUs in the multiple row ALU arrangement of the present invention; furthermore, it is to be understood that any cell element and/or functionality of a cell element that has been disclosed in the previous applications of the present applicant can be implemented as side-ALUs, for example ALUs combined with FPGA-grids, VLIW-ALUs, DSP-cores, floating point units, any kind of accelerators, peripheral interfaces such as memory- and/or I/O-busses as already known in the art or to be described in future upcoming technologies and the like.

It should also be understood that whereas the ALUs in the rows of ALU-stages in the ALU-arrangement of the present invention are disclosed and described above and below to be ALUs capable of carrying out a given set of instructions, such as a reduced instruction set having a restricted latency, at least some of the ALUs in the path may be constructed and/or designed to have other functionality. Where it is reasonable to assume that algorithms need to be processed on the arrangement of the present invention that require huge amounts of floating point instructions, despite the comments above, at least some of the ALUs in the ALU-stage path and not only in the side-ALUs may comprise floating point capability. Where performance is an issue and ALUs need to be implemented having a functionality executed slower than other functionalities but not used frequently, it would be possible to slow down the clock in cases where an OpCode referring to this functionality is definitely or conditionally to be executed. The clock frequency would be indicated in the instructions(s) to be loaded for the entire ALU-arrangement as might be done in other cases as well. Also, when needed, some of the ALUs in at least one of the columns may be configurable themselves so that instructions can be defined by referring to an (if necessary preconfigured) configuration. Here, the status that would be transferred from one row to the other and/or between columns of ALUs would be the overall status of the ((re)configurable) array. This would allow for defining a very efficient way of selecting instructions. It should be understood that in a case like that, the instructions used in the invention to be loaded into an ALU could comprise an entire configuration and/or a multiplicity of configurations that can be selected using other instructions, trigger values and so forth.

Furthermore, it should be understood that in certain cases units as described above as possible alternatives to common place classic ALUs for the side-ALUs (or, more precisely, side-units) could also be used in at least some parts of the data path, that is for at least one ALU in the ALU-arrangement of the present invention; accordingly, one or more “ALU-like” element(s) may be built as lookup-tables, RAM, ROM, FIFO or other memories, I/O-interface(s), FPGAs, DSP-cores, VLIW-units or combination(s) thereof. It should also be noted that even in this case a plurality of operands processing and altering and/or combining units, that is “conventional” ALUs, even if having a reduced set of operand processing possibilities by omitting e.g. multiplier stage, will remain. Furthermore, it should be noted that even in such a case a significant difference from the present invention to a conventional XPP or other reconfigurable array exists in that the definition of the status is completely different.

In a conventional XPP, the status is distributed over the entire array and only in considering the entire array with all trigger vectors exchanged between ALUs thereof and protocol-related states can the status of the array be defined. In contrast, the present invention also has a clearly defined status at each row (stage) which can be transferred from row to row. Further to the exchange of such processor-like status from row to row, it is also possible to exchange status (or status-like) information between different columns of the device according to the invention. This is clearly different from any known processor.

Operands connected in parallel and/or switched and/or parallelized allow for the execution of operations of the remaining data paths, in particular the ALU-data paths. Thus, data processing can be parallelized on instruction level, allowing for the exploitation of instruction level parallelism (ILP).

### Register Access

Each ALU in the ALU-stage arrangement 0130 may, in the preferred embodiment of the present invention, select any register of the processor register 0109 as operand register 0140 via the respective multiplexer/register stage 0105, 0106, 0107. The result of the operation and/or calculation 0141, 0142, 0143, 0144 of each ALU-stage is sent to the respective subsequent stage(s) that is either, in the normal case, the directly succeeding stage and/or one or more stages thereafter, and can thus be selected by the multiplexer-/register stage 0105, 0106, 0107 thereof as operand. The same holds for status information which can be sent to the directly succeeding stage and/or can be sent to one or more stages further downstream.

Multiplexer stage 0111 is connected via a bus system 0145, and serves to transfer the results of the operations/calculations 0141, 0142, 0143, 0144 according to the instruction to be executed for writing into the processor register 0109.

### Implementation of Asynchronous Concatenation of ALUs in Plural Parallel ALU-Paths

The embodiments previously described have a disadvantage remaining: The ALU-stage path should operate completely without pipelining to obtain maximum performance in particular for algorithms such as CABAC, given the fact that only then can all ALU-stages carry out operations in every clock-cycle effectively. Pipelining has no advantage here, given the fact that calculation operations are linearly (sequentially) dependent from one another in a temporal manner resulting in the fact that a new operation could only be started once the result of the last pipeline stage is present. Thus, most of the ALU-stages would always run empty. Accordingly, an asynchronous connection of the ALU-stages it is preferred. Based on transistor geometries according to the state of the art, this is no problem, given the fact that the single ALUs within the ALU-stages according to the invention comprise only fast and thus simple commands such as ADD, SUB, AND, OR, XOR, SL, SR, CMP and so forth in the preferred embodiment, thus allowing an asynchroneous coupling of a plurality of ALU-stages, for example four, with several 100 MHz.

However, branching in the code within the ALU-stage arrangement may cause timing problems as the corresponding ALUs are to change their instructions at runtime asynchronously, leading to an increase of runtime.

Now, given the fact that the ALUs within the ALU-stage arrangement are designed very simple in the preferred embodiment, a plurality of ALU-stages can be implemented, each ALU-stage being configured in a fixed manner for one of the possible branches.

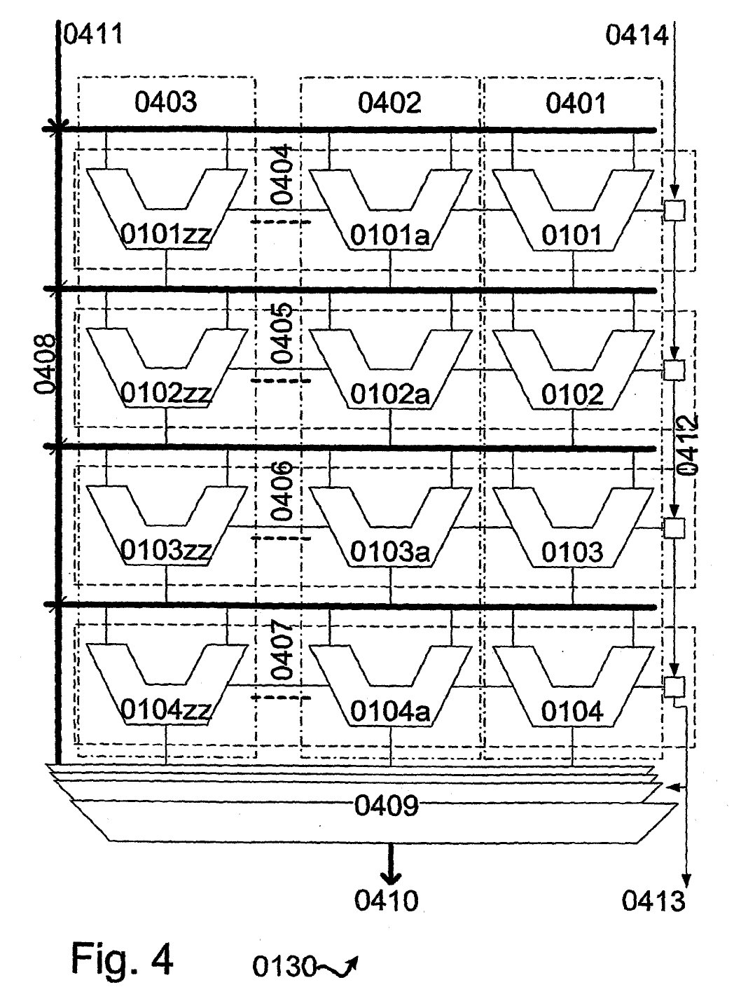

FIG. 4 shows a corresponding arrangement wherein the ALU-stage arrangement 0401 (corresponding to 0101 . . . 0104 in the previous embodiment) is duplicated in a multiple way, thus implementing for branching zz-ALU-stages arrangements 0402={0101a . . . 0104a} to 0403={0101zz . . . 0104zz}. In each ALU-stage arrangement 0401 to 0403 the operation is defined by specific instructions of the OpCode not to be altered during the execution. The instructions comprise the specific ALU command and the source of each operand for each single ALU as well as the target register of any. Be it noted that the register set might be defined to be compatible with register and/or stack machine processor models. The status signals are transferred from one ALU-stage to the next 0412. In this way, the status signals inputted into one ALU-row 0404, 0405, 0406, 0407 may select the respective active ALU(s) in one row which then propagate(s) its status signal(s) to the subsequent row. By activating an ALU within an ALU-row depending on the incoming status signal 0412, a concatenation of the active ALUs for pipelining is obtained producing a “virtual” path of those jumps actually to be executed within the grid/net. Each ALU has, via a bus system 0408, cmp. FIG. 4, access to the register set (via bus 0411) and to the result of the ALUs in the upstream ALU-rows. (It will be understood that in FIG. 4 the use of reference signs will differ for some elements compared to reference signs used in FIG. 1; e.g. 0408 corresponds to 0140, 0409 corresponds to 0111 and 0410 to 0145. Similar differences might occur between other pairs of figures as well.) The complete processing within the ALUs and the transmission of data signals and status signals is carried out in an asynchronous manner. Several multiplexers 0409 at the output of the ALU-stages select in dependence of the incoming status signals 0413 the results which are actually to be delivered and to be written into the data register (0410) in accordance with the jumps carried out virtually. The first ALU-row 0404 receives the status signals 0414 from the status register of the processor. The status signal created within the ALU-rows corresponds, as described above, to the status of the “virtual” path, and thus the data path jumped to and actually run through, and is written back via 0413 to the status register 0920 of the processor.

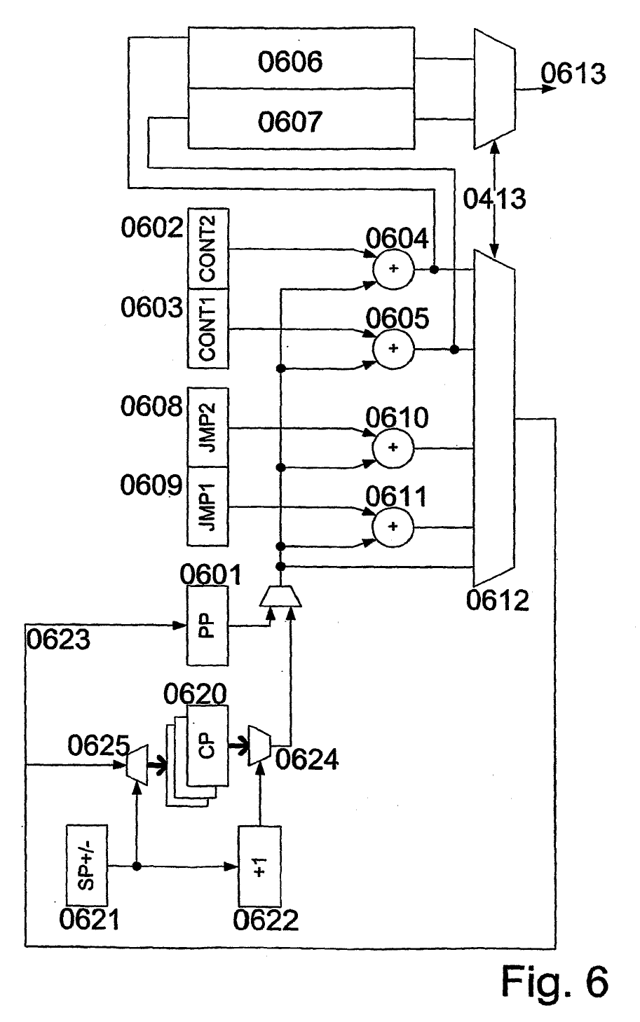

A particular advantage of this ALU implementation resides in that the ALU-stages arrangement 0401, 0402, 0403 can not only operate as alternative paths of branches but can also be used for parallel processing of instructions in instruction level parallelism (ILP), several ALUs in one ALU-row processing operands at the same time that are all used in one of the subsequent rows and/or written into the register. A possible implementation of a control circuitry of the program pointer for the ALU-unit is described in FIG. 6. Details thereof will be described below.

### Load-Store

In a preferred embodiment of the technology according to the present invention, the load/store processor is integrated in a side element, compare e.g. 0131, although in that case 0131 is preferably referred to not as a “side-ALU” but as a side-L/S-(load/store)-unit. This unit allows parallel and independent access to the memory. In particular, a plurality of side-L/S-units may be provided accessing different memories, memory parts and/or memory-hierarchies. For example, L/S-units can be provided for fast access to internal lookup tables as well as for external memory accesses. It should be noted explicitly that the L/S-unit(s) need not necessarily be implemented as side-unit(s) but could be integrated into the processor as is known in the prior art. For the optimised access to lookup-tables an additional load-store command is preferably used (MCOPY) that in the first cycle loads a data word into the memory in a load access and in a second cycle writes to another location in the memory using a store access of the data word. The command is particularly advantageous if for example the memory is connected to a processor using a multiport interface, for example a dual port or two port interface, allowing for simultaneous read and write access to the memory. In this way, a new load instruction can be carried out directly in the next cycle following the MCOPY instruction. The load instruction accesses the same memory during the store access of MCOPY in parallel.

### XMP Processor

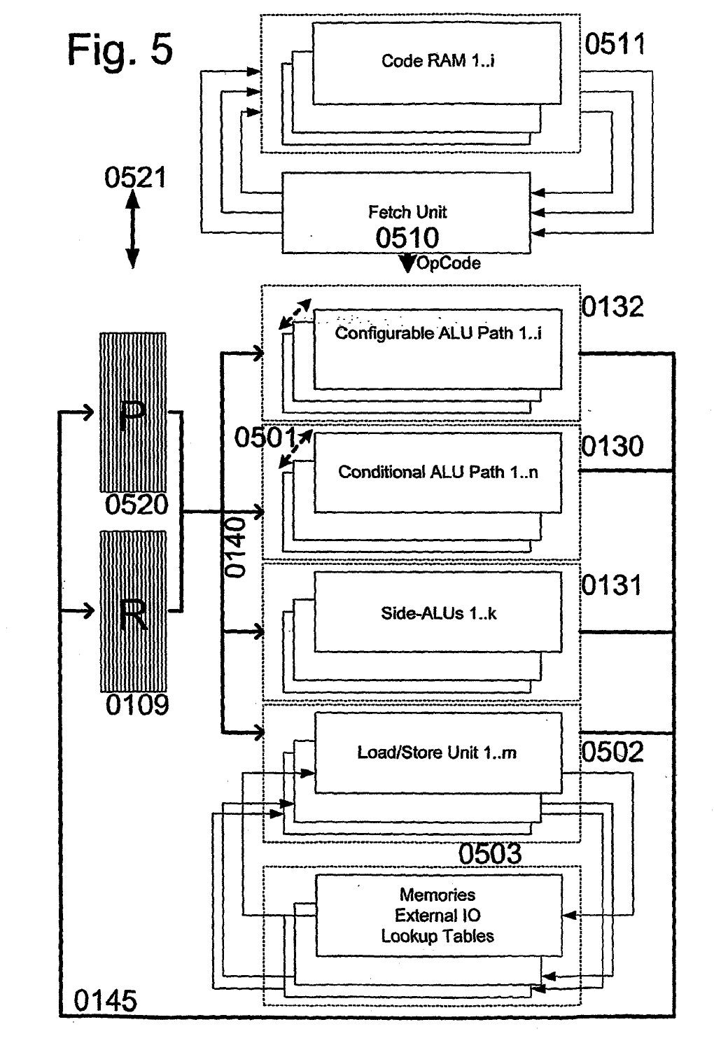

FIG. 5 shows an overall design of an XMP processor module. In the core, ALU-stage arrangements 0130 are provided that can exchange data with one another as necessary in the way disclosed for the preferred embodiment shown in FIG. 4 as indicated by the data path arrow 0501. In parallel thereto, side-ALUs 0131 and load/store-units 0502 are provided, where again a plurality of load/store-units may be implemented accessing memory and/or lookup tables 0503 in parallel. The data processing unit 0130 and 0131 and load/store-unit 0502 are loaded with data (and status information) from the register 0109 via the bus system 0140. Results are written back to 0109 via the bus system 0145.

In parallel thereto, as OpCode-fetcher 0510 is provided and working in parallel, loading the subsequently following respective OpCodes. Preferably, a plurality of possible subsequent OpCodes are loaded in parallel so that no time is lost for loading the target OpCode. In order to simplify parallel loading of OpCodes, the OpCode-fetcher may access a plurality of code memories 0511 in parallel.

In order to allow for a simple and highly performing integration into an XPP processor and/or to allow for the coupling of a plurality of XMPs and/or a plurality of XMPs and XPPs, particular register P0520 is implemented. The register acts as input-/output port 0521 to the XPP and to the XMPs. The port conforms to the protocol implemented on the XPP or other XMPs and/or translates such protocols. Reference is made in particular to the RDY/ACK handshake protocol as described in PCT/EP 03/09957 (PACT34/PCTac), PCT/DE 03/00489 (PACT16/PCTD), PCT/EP 02/02403 (PACT18/PCTE), PCT/DE 97/02949 (PACT02/PCT).

Data input from external sources are written with a RDY flag into P setting the VALID-flag in the register. By the read access to the corresponding register, the VALID-flag is reset. If VALID is not set, the execution stops during register read access until data have been written into the register and VALID has been set. If the register is empty (no VALID), external write accesses are prompted immediately with an ACK-handshake. In case the register contains valid data, externally written data is not accepted and no ACK-handshake is sent until the register has been read by the XMP. For output registers, VALID and RDY are set whenever new data has been written in. RDY and VALID will be reset by receiving an ACK from external. If ACK is not set, the execution of a further register write access is stopped until data from external has been read out of the register and VALID has been reset. If the register is full (VALID) the RDY-handshake is signalled externally and will be reset as soon as the data has been read externally and has been prompted by the ACK-handshake. Without RDY being set the register can not be read from externally.

It has to be noted that whereas the above refers to one single stage for the register, registers comprising multiple register stages, e.g. FIFOs, can be implemented. For explanation of some of the protocols that may be used, reference is made for purposes of disclosure to PCT/DE 97/02949 (PACT02/PCT), PCT/DE 03/00489 (PACT16/PCTD), PCT/EP 02/02403 (PACT18/PCTE).

### Fetch-Unit

FIG. 6 shows an implementation of the OpCode-fetch-unit. The program pointer 0601 points to the respective OpCode of a cycle currently executed. Within one OpCode instruction a plurality of jumps to subsequent OpCodes may occur. It is to be distinguished between several kinds of jumps:
a) CONT is relative to the program pointer and points to the OpCode to be subsequently executed, loaded in parallel to the data processing. The processing of CONT corresponds to the incrementing of a program pointer taking place in parallel to the ALU data processing and to the loading of the next OpCodes of conventional processors according to the state of the art. Therefore, CONT does not need an additional cycle for execution.
b) JMP is relative to the program pointer and points to the OpCode to be executed subsequently that is jumped to. According to the JMP of the prior art, the program pointer is calculated anew and in the next cycle (t+1) a new OpCode is loaded which is then executed in cycle (t+2). Therefore, one data processing cycle is lost during processing of JMP.

During linear processing of program code, the instruction CONT is executed with a parameter “one” being transmitted, corresponding to the common implementation of the program pointer. Additionally, this parameter transferred can differ from “one” thus causing a relative jump by adding this parameter to the program pointer, the jump being effected in the forward- or backward direction depending on the sign of the parameter. During the ALU-data processing the jump will be calculated and executed. A plurality of CONT-branches may be implemented thus supporting a plurality of jump targets without loosing an execution cycle. Shown are two CONT-branches 0602, 0603, one having for example a parameter “one” thus pointing to the instruction following immediately thereafter while the second can be e.g. −14 and thus having the effect of a jump to an OpCode stored fourteen memory locations back.

Multiple CONT-parameters, e.g. two, may be combined with the program pointer (as obtained by counting 0604, 0605) and a possible subsequent OpCode may be read from multiple, e.g. two code memories 0606, 0607. At the end of the ALU data processing the OpCode 0613 to be actually carried out is selected in response to the status signal, that is the jump target is selected at the end of the processing using the “virtual” path. Due to the fact that all possible OpCodes have been preloaded already, the data processing can continue in the cycle following immediately thereafter.

The execution of CONTs is comparatively expensive in view of the fact that the memory accesses to the code memory have to be executed in parallel and/or a multiple and/or a multi-port memory has to be used to allow for parallel loading of several OpCodes.

In contrast, JMP corresponds to the prior art. In case of a JMP the relative parameters 0608, 0609 are combined with a program pointer and a program pointer is using the multiplexer 0612. In the next clock-cycle (cycle+1) the code memory 0607, 0606 is addressed via the program pointer. The jump to the next OpCode is carried out and in response, the next OpCode is carried out in the next cycle (cycle+2). Therefore, although one processing cycle is lost, no additional costs are involved.

In order to optimize a combination of cost efficiency and performance the XMP implements both methods. Within one complex OpCode a set of subsequent operations can be jumped to directly and without additional delay cycles using CONT. If additional jumps within a complex OpCode are used, JMP may be used.

Furthermore, there is a particular method of executing CALLs. Basically, CALLs may be implemented corresponding to the prior art using an external stack not shown in FIG. 6. Shown, however, is an optional and/or additional way of implementing a minimum return address stack in the fetch unit. The stack is designed from a set of registers 0620, into which the addresses are written to which the program pointer will point next, 0623. In one embodiment, the stack pointer is implemented as an up-down-counter 0621 and points to the current writing position of the stack, while the value (pointer+1) 0622 is pointing to the current read position. Using a demultiplexer 0625, 0623, the next program pointer address is written into the register 0620 using a multiplexer 0624 for reading from the stack. Using the small register stack a number of CALL-RET jumps determined by the number of the register 0620 may be executed without requiring memory stack access. In this way, the implementation of a stack is not needed for small processors and at the same time the access is more performance-efficient than the usual stack access.

Commonly, the stack registers need not be saved by or for target applications aimed at, compare for example CABAC. However, should this be the case, a certain amount of registers could be duplicated and switched following a jump and/or optionally a stack is implemented, preferably used only when absolutely necessary and accepting the inherent loss of performance connected therewith.

In the implementation presented as an example two CONT and two JMP are provided; however, it should be explicitly noted that the number is depending only on the implementation and can vary arbitrarily between 0 and n and can be different in particular for CONT and JMP.

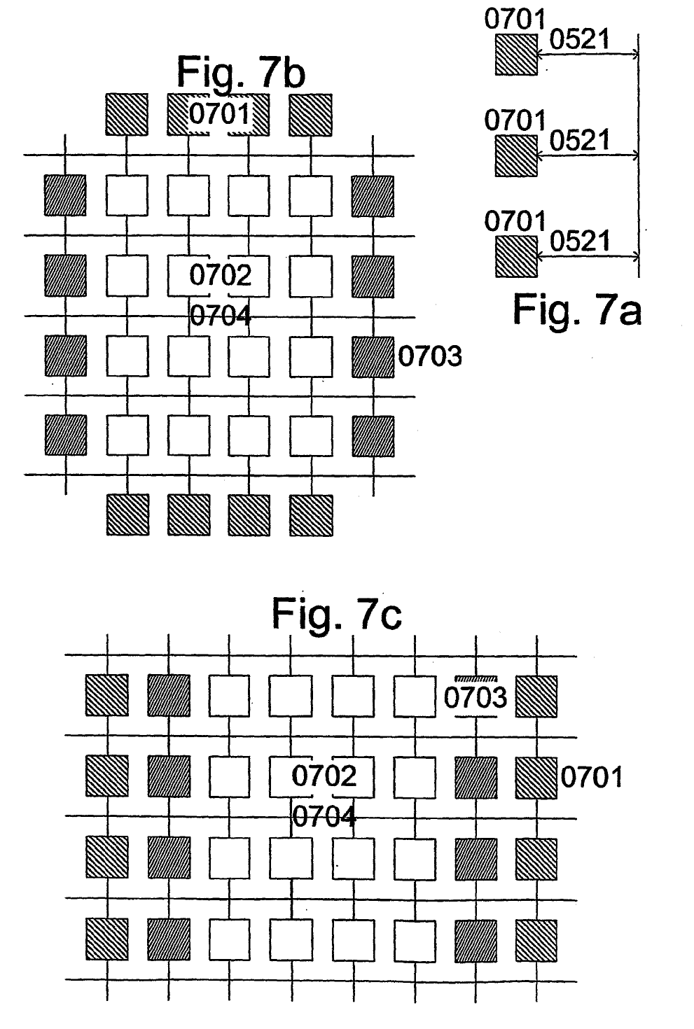

FIG. 7 shows the interconnection of a plurality of XMPs and their coupling to an XPP.

In FIG. 7a a plurality of XMPs (0701) are connected via the P-register and the port 0521 with each other. Preferably, a bus system configurable at runtime such as those used in the XPP is used. In this way, all registers of P can, as is preferred, be connected via the bus system independently. In this respect, the register P corresponds to an arrangement of a plurality of input-/output-registers of the XPP technology as described for example in PCT/DE 97/02949 (PACT02/PCT), PCT/DE 98/00456 (PACT07/PCT), PCT/DE 03/00489 (PACT16/PCTD), PCT/EP 01/11593 (PACT22aII/PCTE) and PCT/EP 03/09957 (PACT34/PCTac).

FIG. 7b and FIG. 7c show possible couplings of the XMP 0701 to an XPP processor, here shown to comprise an array of ALU-PAEs 0702 and a plurality of RAM-PAEs 0703 connected to each other via a configurable bus system 0704. As described in FIG. 7a, the XMP disclosed is connected using the bus system 0704 in one embodiment.

It is to be noted explicitly that basically XMP processors can be integrated into the array of an XPP in the very same manner as an ALU-PAE, a SEQ-PAE and/or instead of SEQ-PAEs, in particular in an XPP according to PCT/EP 03/09957 (PACT34/PCTac) or in the way any other PAE could be integrated.

### Examples of Programming

The subsequent code examples are given for an XMP processor having the following parameters:
register set R: 16 registers
register set P: 16 registers
4 ALU-stages (0404, 0405, 0406, 0407)
2 parallel ALU-paths (0401 and 0402)
1 side ALU: multiplier
1 load-store-unit
2 parallel code-RAMs
2 CONT-jumps per operation
(e.g. HPC and LPC, cmp. attachment)
2 JMP-jumps per operation

Video-Codecs according to best art known use the CABAC algorithm for entropy coding. The most relevant routine within the CABAC is shown subsequently as 3-address-assembler-code:

| | |
|---|---|
| LOAD state, *stateptr | ; RangeLPS = ... |
| SHR range2, range, #14 | |
| AND range2, range2, #3 | |
| SHL state2, state, #2 | |
| OR adr1, state2, range2 | |
| ADD adr1, adr1, lpsrangeptr | |
| LOAD rangelps, *adr1 | |
| SUB range, range, rangelps | ; range −= ... |

| | |
|---|---|
| AND bit, state, #1 | ; bit = (*state) & 1 |

| | |
|---|---|
| CMP low, range | ; if (low < range) |
| JMP GE L1 | ; jump if previous condition met |

| | |
|---|---|
| ADD state3, mpsstateptr, state | ; *state = mps_state[*state] |
| LOAD state4, *state3 | |
| STORE stateptr, state4 | |
| JMP L2 | |
| L1: XOR bit2, bit, #1 | |
| SUB low, low, range | |
| MOV range, rangelps | |

| | |
|---|---|
| ADD state3, lpsstateptr, state | ; *state = lps_state[*state] |
| LOAD state4, *state3 | |
| STORE stateptr, state4 | |
| L2: CMP range, 0x10000 | ; renorm_cabac_decoder function |
| JMP GE L3 | ; while-loop exit condition |
| SHL range, range, #2 | |
| SHL low, low, #2 | |
| SUB bitsleft, bitsleft, #1 | ; --bits_left |
| JMP NZ L2 | ; jump if not zero |
| CMP bytestreamptr, | |
| bytestreamendptr | |
| JMP GE L4 | |
| LOAD byte, *bytestreamptr | |
| ADD low, low, byte | ; low += *bytestream |
| L4: ADD bytestreamptr, | |
| bytestreamptr, #1 | |
| MOV bitsleft, #8 | |
| JMP L2 | |
| L3: | |

The routine contains 34 assembler OpCodes and correspondingly at least as many processing cycles. Additionally, it has to be considered that jumps normally use two cycles and may lead to a pipeline stall requiring additional cycles.

The routine is recoded subsequently so that it can be executed using an XMP processor, having in its preferred embodiment four ALU-stages and no pipeline between the ALU-stages. Furthermore, two parallel ALU-stage parts are implemented, the second part executing an OpCode-implicit jump without need for an explicit jump OpCode or without risk of a pipeline stall. Within the ALU-path, that is both ALU-strip-paths in common, implicit conditional jumps can be executed. During processing of an OpCode both possible subsequent OpCodes are loaded in parallel and at the end of an execution the OpCode to be jumped to is selected without requiring an additional cycle. Furthermore, the processor in the preferred embodiment comprises a load/store-unit parallel to the ALU-stage paths and executing in parallel.

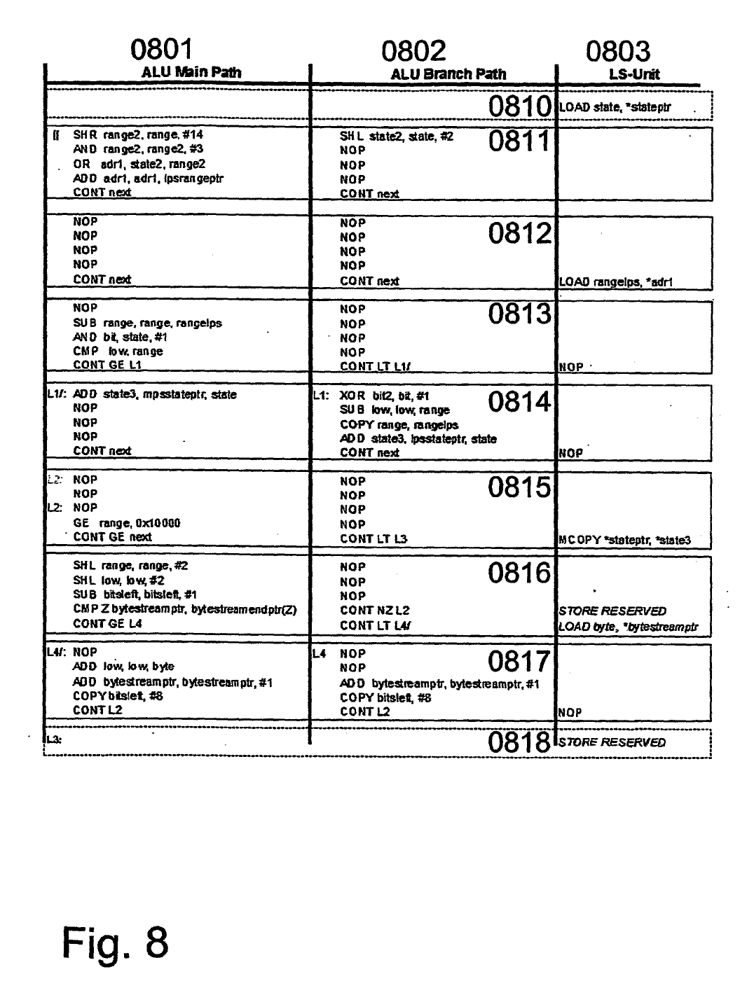

The design of the different elements is shown in FIG. 8. 0801 denotes the main ALU-stage path, 0802 denotes the ALU-stage path executed in case of a branching. 0803 includes the processing of the load-/store-unit, one load-/store operation being executed per four ALU-stage operations (that is during one ALU-stage cycle).

Corresponding to the frames indicated (0810, 0811, 0812, 0813, 0814, 0815, 0816, 0817,0818), four ALU-stage instructions form one OpCode per clock cycle. The OpCode comprises both ALU-stages (four instructions each plus jump target) and the load-/store-instruction.

In 0811 the first instructions are executed in parallel in 0801 and 0802 and the results are processed subsequently in data path 0801.

In 0814 either 0801 or 0802 are executed.

In 0816 the execution is either stopped following SUB using CONT NZ L2 or continued using CMP. Depending on the result of CMP, the execution is either continued using CONT GE L4 or CONT LT L4/. It should be noted that in this example three CONTs within the OpCode occur which is not allowed according to the embodiment in the example. Here, a CONT would have to be replaced by a JMP.

MCOPY 0815 copies the memory location *state3 to *stateprt and reads during execution cycle 0815 the data from state3. In 0816 data is written to *stateptr; simultaneously read access to the memory already takes place using LOAD in 0816.

For jumping into the routine, the caller (calling routine) executes the LOAD 0804. When jumping out of the routine therefore the calling routine has to attend to not accessing the memory for writing in a first subsequent cycle due to MCOPY.

The instruction CONT points to the address of the OpCode to be executed next. Preferably it is translated by the assembler in such a way that it does not appear as an explicit instruction but simply adds the jump target relative to the offset of the program pointer.

The corresponding assembler program can be programmed as listed hereinafter: three { } brackets are used for the description of an OpCode, the first bracket containing the four instructions and the relative program pointer target of the main ALU-stage path, the second bracket including the corresponding branching ALU-stage path and the third bracket determining an OpCode for the load-/store-unit.

Assembler Code Construction:

| L: | { |
|---|---|
| | main-ALU-stages instructions (4) |
| | jump to next OpCode |
| | } |
| L/: | { |

```
    branching-ALU-stages instructions (4)
    jump to next OpCode
}
{
    load-store instruction (1)
}
```

During execution of four ALU-stages instructions only one load-store instruction is executed, as due to latency and processor core external accesses more runtime is needed. For each bracket of the main- and branching-ALU-stage block a label can be defined specifying jump targets as known in the prior art. For example, L: as indicated and L/: as indicated is used for the inverse jump target.

There is no need to define a jump to the next instruction (CONT) as long as the next OpCode to be executed is the one to be addressed by the program pointer +1 (PP++).

Furthermore, no “filling” NOPs are needed.

| | { |
|---|---|
| | SHR range2, range, #14 |
| | AND range2, range2, #3 |
| | }{ |
| | }{ |
| | LOAD state, *stateptr |
| | } |
| | { |
| | SHL state2, state, #2 |
| | OR adr1, state2, range2 |
| | ADD adr1, adr1, lpsrangeptr |
| | }{ |
| | }{ |
| | } |
| | { |
| | }{ |
| | }{ |
| | LOAD rangelps, *adr1 |
| | } |
| | { |
| | SUB range, range, rangelps |
| | AND bit, state, #1 |
| | CMP low, range |
| | CONT GE L1 |
| | }{ |
| | CONT LT L1/ |
| | }{ |
| | } |
| L1/: | { |
| | ADD state3, mpsstateptr, state |
| | CONT next |
| L1: | }{ |
| | XOR bit2, bit, #1 |
| | SUB low, low, range |
| | MOV range, rangelps |
| | ADD state3, lpsstateptr, state |
| | }{ |
| | } |
| L2: | { |
| | CMP range, 0x10000 |
| | CONT GE Next |
| L2/: | }{ |
| | CONT L3(C) |
| | }{ |
| | MCOPY *stateptr *state3 |
| | } |
| | { |
| | SHL range, range, #2 |
| | SHL low, low, #2 |
| | SUB bitsleft, bitsleft, #1 |
| | CONT Z next |
| | }{ |
| | CONT NZ L2 |
| | }{ |
| | ; RESERVED (MCOPY) |
| | } |
| | { |
| | CMP bytestreamptr, bytestreamendptr |
| | CONT GE L4 |
| | }{ |
| | CONT LT L4/ |
| | }{ |
| | LOAD byte, *bytestreamptr |
| | } |
| L4/: | { |

```
    ADD low, low, byte
    ADD bytestreamptr, bytestreamptr, #1
    MOV bitsleft, #8
    CONT L2
}{
    ADD bytestreamptr, bytestreamptr, #1
    MOV bitsleft, #8
    CONT L2
}{
}
```

L3:

### Optimized Implementation

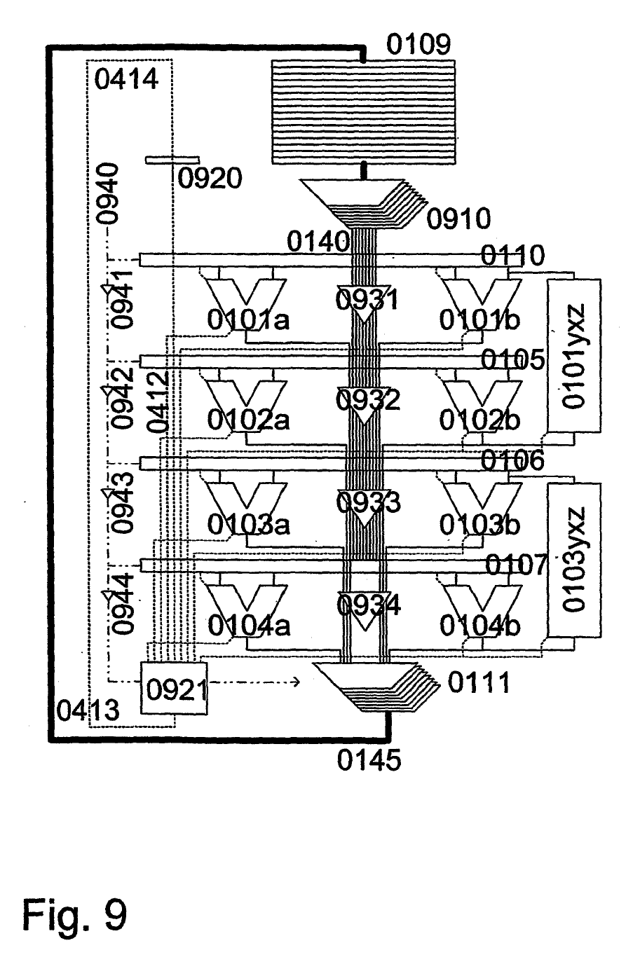

FIG. 9 shows in detail a design of a data path according to the present invention, wherein a plurality of details as described above yet not shown for simplicity in FIG. 1-4 is included. Parallel to two ALU-strip-paths two special units 0101xyz, 0103xyz are implemented for each strip, operating instead of the ALU-path 0101 . . . 4b. The special units can include operations that are more complex and/or require more runtime, that is operations that are executed during the run-time of two or, should it be implemented in a different way and/or wished in the present embodiment, more ALU-stages. In the embodiment of FIG. 9, special units are adapted for example for executing a count-leading-zeros DSP-instruction in one cycle. Special units may comprise memories such as RAMs, ROMs, LUTs and so forth as well as any kind of FPGA circuitry and/or peripheral function, and/or accelerator ASIC functionality. A further unit which may be used as a side-unit, as an ALU-PAE or as part of an ALU-chain is disclosed in attachment 2.

Furthermore, an additional multiplexer stage 0910 is provided selecting from the plurality of registers 0109 those which are to be used in a further data processing per clock cycle and connects them to 0140. In this way, the number of registers 0109 can be increased significantly without enlarging bus 0140 or increasing complexity and latency of multiplexers 0110, 0105 . . . 0107. The status register 0920 and the control path 0414, 0412, 0413 are also shown. Control unit 0921 surveys the incoming status signal. It selects the valid data path in response to the operation and controls the code-fetcher (CONT) and the jumps (JMP) according to the state in the ALU-path.

It has been proven by implementing the unit that in view of the signal delay and the power dissipation of the data bus it is preferable to use a chain of driver stages instead of one single driver stage following multiplexer 0110 or instead of implementing a tree structure of drivers, the chain being constructed preferably in parallel to the ALUs to amplify the signals from the registers. By implementing the drivers in parallel to the ALUs, smaller, more energy efficient drivers can be used (0931, 0932, 0933, 0934). Their high delay is acceptable, since even in the most energy efficient and thus slowest variant of the drivers the buffered signals are transferred faster to downstream ALUs than signals can be transferred to downstream ALUs via the ALUs parallel to the driver. The drivers amplify both the signals of the data register 0109 as well as those of the respective previous ALU-stages. It should be understood that these drivers are not considered vital and are thus purely optional.

In implementing the unit, a further problem occurs in that i case the optionally provided registers in the multiplexer stages 0105, 0106, 0107 are not used, all signals run through the entire gates of the ALU-paths in an asynchronous way. Accordingly, a significant amount of glitches and hazards is caused by switching through successively the logic gates, the glitches and hazards thus comprising no information whatsoever. In this way, on the one hand a significant amount of unwanted noise is created while on the other hand a large amount of energy for recharging the gates is needed. This effect can be suppressed by generating a signal 0940 at the beginning of the processing controlled by the clock unit and directed into a delay chain 0941, 0942, 0943, 0944. The delay members 0941 . . . 0944 are designed such that they delay the signal for the maximum delay time of each ALU-stage. After each delay stage the signal delayed in this manner will be propagated to the stage of the corresponding multiplexer unit 0105 . . . 0107 serving there as an ENABLE-signal to enable the propagation of the input data. If ENABLE is not set, the multiplexers are passive and do not propagate input signals. Only when the ENABLE-signal is set, input signals are propagated. This suppresses glitches and hazards sufficiently since the multiplexer stages can be considered to have a register stage effect in this context. It should be understood that this hazard/glitch reduction is not considered vital and thus is purely optional.

It should be noted that in cases where energy consumption is of concern, a latch can be provided at the output of the multiplexer stage, the latch being set transparent by the ENABLE-signal enabling the data transition, while holding the previous content if ENABLE is not set. This is reducing the (re)charge activity of the gates downstream significantly.

### Optimization of Jump Operations and Configurable ALU-Path

The comparatively low clock frequency of the circuit and/or the circuitry and/or the I/O constructed therewith allow for a further optimisation that makes it possible to reduce the multiple code memory to one. Here, a plurality of code-memory accesses is carried out within one ALU-stage cycle and the plurality of instruction fetch accesses to different program pointers described are now carried out sequentially one after the other. In order to carry out n instruction fetch accesses within the ALU-stage clock cycle, the code memory interface is operated with the n-times ALU-stage clock frequency.

If the ALU-path is completely programmable, a disadvantage may be considered to reside in the fact that a very large instruction word has to be loaded. At the same time it is, as has been described, advantageous to carry out jumps and branches fast and without loss of clock cycles thus having an increased hardware complexity as a result.

The frequency of jumps can be minimized by implementing a new configurable ALU-unit 0132 in parallel to the ALU-units 0130 and 0131 embedded in a similar way in the overall chip/processor design. This unit generally has ALU-stages identical to those of 0130 as far as possible; however, a basic difference resides in that the function and interconnection of the ALU-stages in the new ALU-unit 0132 is not determined by an instruction loaded in a cycle-wise manner but is configured. That means that the function and/or connection/interconnection can be determined by one or more instructions word(s) and remains the same for a plurality of clock cycles until one or more new instruction words alter the configuration. It should be noted that one or more ALU-stage paths can be implemented in 0132, thus providing several configurable paths. There also is a possibility of using both instruction loaded ALUs and configurable elements within one strip.

In using a jump having a particular jump instruction or being characterized by for example an exception address, program execution can be transferred to one (or more) of the ALU-stages in 0132 which are thus activated to load data from the register file, process data and write them back, the register sources and targets being preconfigured.

Now, it is possible to configure core routines used frequently and/or sub-routines to be jumped to in a fast manner into one or a plurality of such preconfigured and/or configurable ALU-stages. For example, the core of the CABAC algorithm can be configured in one or more of these preconfigured ALU-stages and then be jumped to without loss of clock cycles. In such a case, no operation for loading CABAC instructions other than a calling or jumping command to invoke the preconfigured algorithms is needed, accelerating processing while reducing power consumption due to the decreased loading of commands.

In order to implement configurable ALU-stages, these can either be multiplied and/or a configuration register is simply multiplied and then one of the configuration registers is selected prior to activation.

The possibility to implement methods of data processing such as wave reconfiguration and so forth in the configurable ALU stages is to be noted (compare e.g. PCT/DE 99/00504=PACT10b/PCT, PCT/DE 99/00505=PACT10c/PCT, PCT/DE 00/01869=PACT13/PCT).

It should be noted that the implementation of a plurality of configurable ALU-stages has proven to be particularly energy efficient. Furthermore, as the parallel loading of a plurality of OpCodes during one execution cycle (in order to enable fast jumps) is not needed, the corresponding memory interface and the code memory can be built significantly smaller thus reducing the overall area despite the additional use of configurable ALU-stages.

### Example CABAC Dispatcher

The assembler code of a dispatcher is, for better understanding of its implementation, indicated as follows:

| | |
|---|---|
| init: | MOV range, #0x1fe |
| | IBIT offset, #9 |
| entry: | MOV cmd, p0 |
| | CMP cmd, 0x8000 |
| | CONT GE dispatch |
| | CMP cmd, 276 |
| | CONT EQ terminate |
| decode: | |
| dispatch: | CMP cmd, 0x8001 |
| | CONT EQ init |

A first XMP implementation is described hereinafter. The instruction JMP is an explicit jump instruction requiring one additional clock cycle for fetching the new OpCode as is known in processors of the prior art. The JMP instruction is preferably used in branching where jumps are carried out in the less performance relevant branches of the dispatcher.

| init: | { |
|---|---|
| | MOV range, #01x1fe |
| | IBIT offset, #9 |
| | }{ |
| | }{ |
| | } |
| entry: | { |
| | MOV cmd, p0 |
| | CMP cmd, 0x8000 |
| | CONT GE dispatch |
| | CMP cmd, 276 |
| | JMP EQ terminate |
| | CONT decode |
| | }{ |
| | }{ |
| | } |
| dispatch: | { |

```
    CMP cmd, 0x8001
    CONT EQ init
    CONT bypass
}{
}{
}
```

The routine can be optimised by using the conditional pipe capability of the XMP:

| init: | { |
|---|---|
| | MOV range, #01x1fe |
| | IBIT offset, #9 |
| | }{ |
| | }{ |
| | } |
| entry: | { |

```
    MOV cmd, p0
    CMP cmd, 0x8000
    CMP LT cmd, 276  ; Conditional-Pipe
    JMP EQ terminate
    CONT decode
}{
    NOP
    NOP
    CMP cmd, 0x800  ; Conditional-Pipe
    JMP EQ init
    CONT bypass
}{
}
```

The device of the present invention can be used and operated in a number of ways.

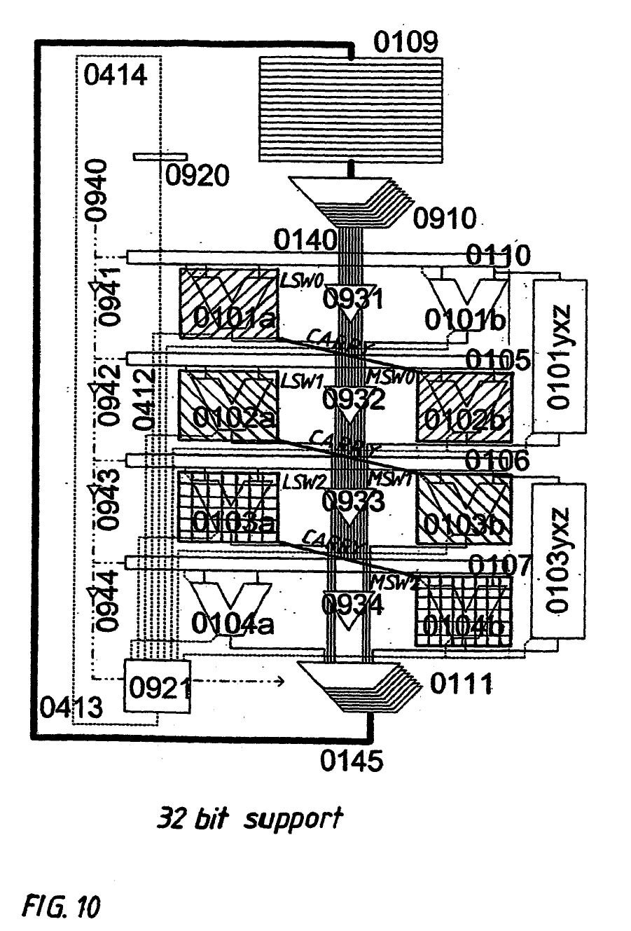

In FIG. 10, a way of obtaining double precision operations is disclosed. In the figure, a carry-signal from the result on one ALU-stage is transferred to the ALU-stage in the next row on the opposite side. In this way, the upper ALU can calculate the lower significant word result as well as the carry of this result and the lower ALU-stage calculates the most significant word MSW by taking account of the carry-information; for example, in the upper stage ALU on the one side, ADD can be calculated whereas in the opposite half of the subsequent ALU-stage an ADDC (add-carry) is implemented. It is to be noted that as shown in FIG. 10 a plurality of double precision operations can be carried out in the typical embodiment. For example, if four stages of two 16-bit ALUs are provided in an embodiment, three 32-bit double precision operations can be carried out simultaneously by using the arrangement and connection shown in FIG. 10. The remaining two ALUs can be used for other operations or can carry out no operations.

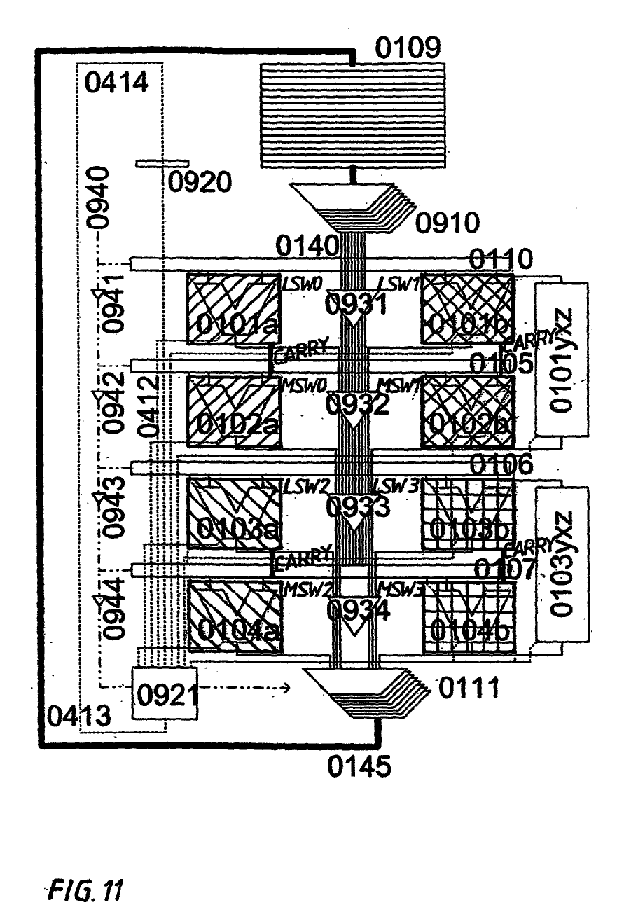

An alternative implementation using different code instructions is shown in FIG. 11. Here, the upper ALU-stage is calculating the least significant word whereas the subsequent ALU-stage is calculating the most significant word, again taking into account, of course, the carry-signal information.

It is to be noted also that the idea of obtaining double precision could be extended to arrangements having more than two columns. In this context, the average skilled person is explicitly advised that although using two columns in the device of the invention is preferred, it is by no means limited to this number. Furthermore, it is feasible in cases where more than two rows and/or columns are provided, to even carry out triple precision or n-tuple precision using the principles of the present invention. It should also be noted that in the typical embodiment, a carry-information will be available to subsequent ALU-stages. Accordingly, no modification of the ALU-arrangement of the present invention is needed.

The embodiment of FIG. 11 does not need any additional hardware connection between the flag units of the respective ALUs. However, for the embodiment of FIG. 10, additional connection lines for transferring CARRY might be provided.

It is also to be anticipated that the way of processing data is highly preferred and advisable in VLIW-like structures adapted to status propagation according to the principle laid out in the present disclosure. It is to be noted that the transferral of status information relating to operand processing results and/or evaluation of conditions from one ALU to another ALU, e.g. one capable of operating independently in the same clock cycle and/or in the same row, is advantageous for enhancing VLIW-processors and thus considered an invention per se.

The transferral of CARRY information from one stage to the next either in the same column or in a neighboring column is not critical with respect to timing as the CARRY information will arrive at the ALU of the subsequent stage approximately at the same time as the input operand data for that ALU. Accordingly, a combination of transferring status information such as CARRY signals to subsequent stages and the exchange of the information regarding activity of neighboring ALUs on the same stage which is not critical in respect to timing either, is allowed in a preferred embodiment. In particular, in a particularly preferred embodiment the information regarding activity of a given cell is not evaluated at the same stage but at a subsequent stage so that the cross-column propagation of status information is not and/or not only effected within one stage under consideration but is effected to at least one neighboring column downstream. (The effects with respect to maximum peak performance of an embodiment like that will be obvious to the skilled person.)

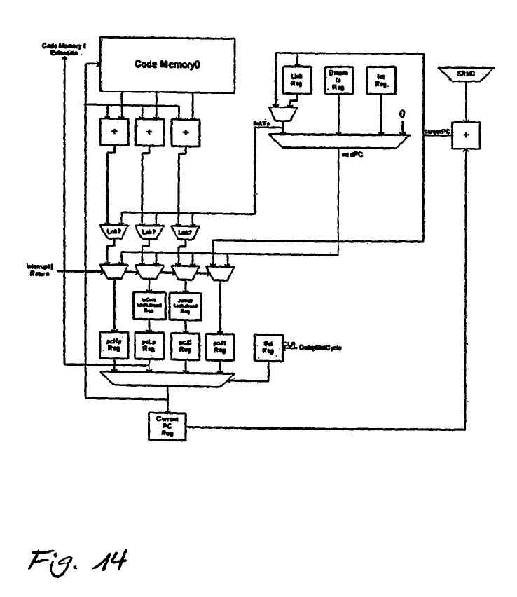

It should be noted that in a preferred embodiment, synthesis of the design gives evidence that it can be operated at approximately 450 MHz implemented in a 90 nm silicon process. It is to be noted that in order to achieve such performance, several measures have to be taken such as, for example, distributing multiplexers such as 0111 in FIG. 1 spatially and/or with respect to e.g. the OpCode-fetcher, a preferred high performance embodiment thereof being shown in FIG. 14, the operation thereof being obvious to the skilled person.

Whereas a complete disclosure of the present invention and/or inventions related thereto yet being independent thereof and thus considered to be subject matter claimable in divisional applications hereto in the future has been given to allow easy understanding of the present invention, the attachment hereto forming part of the disclosure as well will give even more details for one specific embodiment of the present invention. It should be noted that the attachment hereto is in no way to be construed to restrict the scope of the present invention. It will be easily understandable that where in the attachment necessities are spoken of and/or no alternative is given, this simply relates to the fact that there is considered to exist no other implementation of the one particular embodiment disclosed in the attachment that could be disclosed without confusing the average skilled person. This means that obviously a number of alternatives and/or additions will exist and be possible to implement even for those instances where they are not mentioned or stated to be not useful and/or not existent, any such statement being either a literal statement or a statement that can be derived from the attachment by way of interpretation.

However, the following should be noted with respect to the attachment:

In the attachment, reference is made to interfacing FNC-PAEs with an XPP. It should be noted again that in general terms, any protocol whatsoever can be used for interfacing and/or connecting the FNC, that is the preferred embodiment of the design of the present XMP invention. However, it will be obvious to the skilled person that any dataflow protocol is highly preferred and that in particular protocols like RDY/ACK, RDY/ABLE, CREDIT-protocols and/or protocols intermeshing data as well status, control information and/or group information could be used.

Furthermore, with respect to the architecture overview given in the attachment, it is to be stated that the general principle of the invention or a part thereof might be used to modify VLIW processors so as to increase the performance.

With respect to paragraph 2.6 of the attachment, where the OpCode structure of the arrangement of the present invention is shown, that arrangement being designated to be an “FNC-PAE” and/or and “XMP” in the attachment, it is to be noted that the CONT-command referred to above is designated to be HPC and LPC in the attachment as will be easily understood.

With respect to paragraph 2.8.2.1 of the attachment, it should be noted that the use of a link register is advantageous per se and not only in connection with the use multi-row- and/or multi-column ALU-arrangements of the present invention although it presents particular advantages here. By using a program structure where first a link-register is set to the address of a callee, then, in a later instruction the program pointer is set to the value previously stored in the link-register while simultaneously writing the return address of the subroutine called into the link-register. Then, in order to return from the subroutine, the program pointer is set again to the value of the link-register, a penalty-free call-return-implementation of a subroutine can be achieved. This is the case for any given processor architecture and is considered an invention per se.

Furthermore, when returning from the subroutine, the link-register can be set again to point to the start address of the subroutine. This enables the caller to call the subroutine again in only one cycle. For example, if in cycle (t) the last OpCode of the subroutine is executed, then in cycle (t+1) the caller checks a termination condition, sets the link-register to point back to itself, and jumps to the current content of the link-register, all in one OpCode and hence in one cycle. In cycle (t+2) the first OpCode of the subroutine is executed.

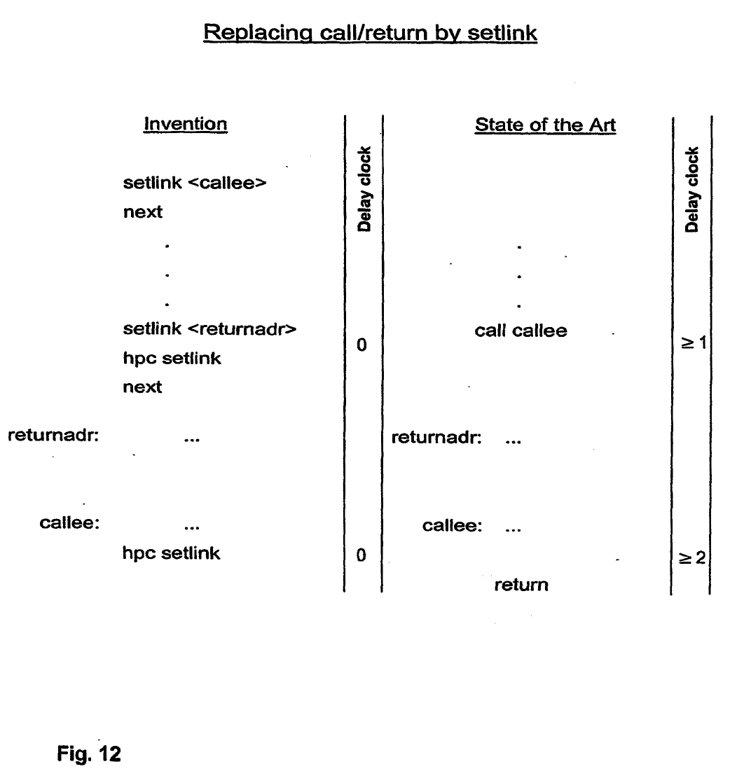

It should also be noted that using link-registers according to the (additional) invention disclosed herein, even nested calls are feasible without additional delay by pushing link-register contents onto a stack in the background while executing other operations prior to calling further subroutines and by popping link-register information from the stack once the (if necessary nested) (sub)subroutine called from the subroutine is returned from. An example thereof is given in FIG. 12.

With respect to the examples disclosing the use of the “opposite path active” and the “opposite path inactive” (OPI/OPA-) conditions, the following is to be noted:

First, in the embodiment shown in FIG. 7 of paragraph 3.6.2, the OPI/OPA-conditions are propagated to ALU-stages of the opposite path at least one stage downstream. This ensures that no timing problems occur. However, it will be understood by the average skilled person, that provided a suitable design and/or sufficiently low clock frequencies are used for the circuitry which might be advantageous with respect to power consumption, it would be possible to propagate OPI/OPA- and/or other state information also within the same stage from one column (S) to another, preferably to a neighboring path (strip).

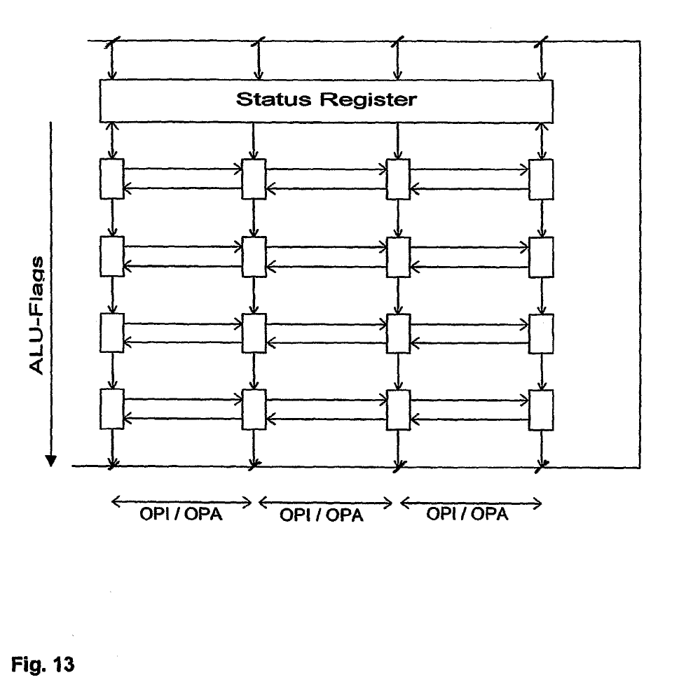

Furthermore, with respect to OPI/OPA-conditions in particular and to the exchange of status information from ALU to ALU, reference is made to FIG. 13. Here, four rows of ALUs arranged in four columns are shown together with a status register and the connections for transferring status information such as ALU-flags. It will be understood that FIG. 13 does not show any path for data (operand) exchange in order to increase the visibility and the ease of understanding. As is obvious, in the embodiment shown in FIG. 13, status information is transferred beginning from a status register to the first row of ALU-units, each ALU-unit therein receiving status information from the register for the respective column. From row to row, status information is propagated in the embodiment shown. Thus, there exists a path for ALU status information to the neighboring downstream ALU in the same column. Then, status information is also exchanged within one row, as indicated by the OPI/OPA-connection lines. In the embodiment shown, only next-neighbours are connected with one another. It will be understood however that this need not be the case and that the connectivity may be a function of the complexity of the circuit. Now, although the arrows between the ALUs in one row are indicated to be OPI/OPA-information, that is information regarding whether the opposite (neighboring) column is active (OPA) or inactive (OPI), it is easily feasible to transfer other information such as overflow flags, condition evaluation flags and so forth from column to column.

It is also noted that at the last row, status information is transferred via a suitable connect to the input of the status register.

The arrangement may now transfer status information from ALU to ALU as follows:

From row to row, ALU-flags may be transferred, for example overflow, carries, zeros and other typical processor flags. Furthermore, information is propagated indicating whether the previous (upstream) ALU-stage and/or ALU-stages have been active or not. In this case, the given ALU-stage can carry out operations depending on whether or not ALU-stages upstream in the same column have been active for the very clock cycle. The upper-most ALU-row (stage) will receive from the status register the output of the down-most ALU-stage obtained in the last clock cycle. Now, a particular advantage of the pre-sent invention resides in that the different columns are not only defining completely independent ALU-pipelines (or ALU-chains) but may communicate status information to one another thus allowing evaluations of branches, conditions and so forth as will be obvious from the above and hereinafter, transferring such information to neighboring columns, be it one, two or more ALUs in the same row or rows downstream. It is also possible to implement conditional execution in the ALU receiving such information. Some conditions that can be tested for are listed in a non-limiting way in table 29 of the attachment. Accordingly, such examples of conditions include “zero-flag set”, “zero-flag not set”, “carry-flag set”, carry-flag not set”, “overflow-flag set”, “overflow-flag not set” and conditions derived therefrom, “opposite ALU-column is active”, “opposite ALU-column is inactive”, “if last condition (in one of the previous cycles) enabled left column (status register flag)”, “if last condition (in one of the previous cycles) enabled right column (status register flag)”, “activate ALU-column if deactivated”. It will be understood that whereas in FIG. 13 only horizontal connections between columns are provided, other implementations might be chosen, providing alternatively and/or additionally non-horizontal connections between columns and/or horizontal and/or non-horizontal non-next-neighboring column connections.

The propagation of such information between different columns is helpful in programming efficient and performant programs in the following way:

First, assume that every ALU is to carry out one instruction, that is all columns are enabled. In such a case, if and as long as no status information is exchanged causing an ALU in one column to not process data any further in response to a condition met in the same or in a neighboring column, the ALUs simply are connected in a chained way. It is to be noted however, that any condition, if not true, may deactivate ALUs downstream in the column the condition is encountered. Now, assume that a program part requires branching to two different branches. One branch can be processed in the left column, the other branch can be processed in the right column. It will be obvious that in the end, only one branch must be executed. Which branch is active will depend on a condition determined during processing. By transferring information regarding this condition, it becomes possible to evaluate only the branch where the condition is met, while preferably taking care that operations in the other branch that is of no concern since the condition for this branch is not met will not be carried out by disabling the corresponding column. Accordingly, information regarding such conditions can be used to activate or deactivate ALUs in the neighboring and/or in the same column. The deactivation can be done using e.g. the “opposite path inactive”—or “opposite path active”—conditions and the respective signals transferred between the columns. It should be noted that disabling a column can be implemented by simply not enabling the propagation of any data output therefrom. Despite the fact that data output from disabled ALUs is not effected in a valid way, it will be easily understood that status information from the disabled ALU and/or column will be propagated nonetheless.

Now, consider a case where disabling of a neighboring column ALU has the result that any ALU downstream thereof in the same neighboring column can be disabled as well. This can be effected by transferring in a first step disabling information to a first ALU in the neighboring column and then propagating the disabling information within this column to down-stream ALUs in this column. Ultimately, such disabling information will be returned to the status register. This is needed for example in cases where in response to one prior condition, very long branches have to be executed. However, there are certain cases where only a limited number of operations in one branch is needed. Here, the previously disabled column has to be “made active” in the subsequent stage again. One example of such a re-activation can be found in cases where two branches merge again and the previously inactive column can be used again. This can be effected by the ACT-(activate-)condition activating an ALU-column downstream in a column of an ALU receiving said ACT-signal and preferably including the ALU receiving said signal if said column is deactivated. Instead of using an ACT-condition, it would obviously be possible to enable the corresponding ALUs and all ALUs downstream thereof in the same column unconditionally unless other conditions are met.

Furthermore, whereas it has been indicated above that a disabling might be useful to reduce power consumption in the evaluation of branches by disabling certain ALUs, it is preferred to implement other conditions as well in order to improve the data processing.

It is thus highly preferred to implement the following:
OPI: Should the ALU in the same row of the opposite column be inactive, then the ALU in the column under consideration is activated.
OPA: Should the ALU in the same row of the opposite column be active, then the ALU in the same row and in the column under consideration is activated as well; otherwise, the ALU in the column considered is inactivated.

In a preferred embodiment, the inactivation takes place no matter what the activation status of ALUs upstream in the column under consideration is. It will be easily understood by the average skilled person that a column deactivated for example by the evaluation of OPA-conditions can be reactivated in an ALU downstream using the activate-(ACT-)condition.

Furthermore, it is also highly preferred to implement evaluations of last conditions, occurring in one of the previous cycles. The attachment in table 29 lists two such conditions, namely LCL and LCR. These have the following meaning:
LCL: In case the last condition previously evaluated, no matter how far back the evaluation thereof has taken place, had enabled the left column, the ALU in the column under consideration is enabled. In case the last previous condition evaluated, no matter how far back the evaluation thereof has taken place, has disabled the left column, the ALU in the column under consideration is disabled. It should be noted that even although this condition checks whether the left column in the previous condition had been enabled, it can now be evaluated with effect to either the left and/or the right column using the LCL condition.
LCR: In the same manner as LCL, the LCR-condition has the following effect: In case the previous condition activated the right column, then the ALU in the column under consideration is activated as well, no matter whether or not the column under consideration is the left or right column. However, in cases where the previous condition disabled the right column, the column under consideration will be deactivated as well.

It should be noted for both LCL and LCR that if the column is active, it is not activated, but stays active. If it is not active, the LCL/LCR conditions have no effect.

It should again be noted that activation/deactivation using LCL, LCR, OPI or OPA are useful in VLIW architectures as well where they can be implemented by register enabling without having adverse effects on clock cycles and the like.

In more general terms, LCL-like conditions evaluate a last previous condition for one or a plurality of columns so as to determine the activation state of the column(s) under consideration for which the LCL-like condition is evaluated.

The following attachment 1 does form part of the present application to be relied upon for the purpose of disclosure and to be published as integrated part of the application.

1. Data processing device comprising a multidimensional array of ALUs,
having a least two dimensions where the number of ALUs in the dimension is greater or equal to 2,
adapted to process data without register caused latency between at least some of the ALUs in the corresponding array.

2. A data processing device in particular according to claim 1, wherein
at least one ALU-chain is provided without registers between ALU-stages of the chain.

3. A data processing device according to claim 1, comprising at least two ALU-pipelines, wherein
signals are provided between ALUs in different pipelines referring to states and/or conditions in the other pipeline.

4. A data processing device according to claim 3, wherein
at least one ALU, preferably an ALU in a pipeline,
preferably each ALU in a pipeline and
preferably each ALU in each pipeline,
is provided that is capable of
evaluating a condition and carrying out an operation in response thereto and/or to not carrying out an operation in response thereto,
the evaluation and execution or non-execution of operations in response thereto taking place preferably in one clock cycle.

5. A data processing device according to claim 4 wherein
at least one unit, preferably an ALU, is provided capable to execute or non-execute operations in response to an evaluation of another unit,
preferably one in the same or in a neighboring pipeline,
preferably either in the same or in an upstream stage.

6. A data processing device for generating a psuedo-noise pattern comprising
a plurality of cells forming part or being capable of being used as a reconfigurable array of cells,
and at least one extension comprising
registers and a number of bit-logic-lines, in particular a stripe of LUTs, each preferably having the same content and/or preferably being a 3:2 LUT.
